(19) United States
(12) Patent Application Publication
(10) Pub. No.: US 2013/0167161 A1
(43) Pub. Date: Jun. 27, 2013

(54) PROCESSING OF RENDERING DATA BY AN OPERATING SYSTEM TO IDENTIFY A CONTEXTUALLY RELEVANT MEDIA OBJECT

(71) Applicants: Eric Liu, Santa Clara, CA (US); Stefan J. Marti, Santa Clara, CA (US); Seung Wook Kim, Cupertino, CA (US)

(72) Inventors: Eric Liu, Santa Clara, CA (US); Stefan J. Marti, Santa Clara, CA (US); Seung Wook Kim, Cupertino, CA (US)

(21) Appl. No.: 13/333,148

(22) Filed: Dec. 21, 2011

(51) Int. Cl. G06F 9/44

(52) U.S. Cl. 719/328

(57) ABSTRACT

Examples disclose a processor to execute an application associated with an operating system to transmit rendering data which identifies visual objects to display by the operating system. Further, the examples provide the operating system to process the rendering data to identify a media object contextually relevant to the rendering data. Additionally, the examples also disclose the operating system to output the rendering data and the identified media object.

### BACKGROUND

In today's technology, users of computing devices rely on electronic documents to provide useful information. These documents may increase value to users through displaying media objects such as pictures, video, and audio. In viewing the documents with the media objects, the user may have an increased aesthetically satisfying experience.

### BRIEF DESCRIPTION OF THE DRAWINGS

In the accompanying drawings, like numerals refer to like components or blocks. The following detailed description references the drawings, wherein:

FIG. 1 is a block diagram of an example computing device including a processor to execute an application to transmit rendering data to an operating system to process and output the rendering data with an identified media object;

FIG. 2 is a block diagram of an example computing device to receive rendering data including a display command and display data, to process and output the rendering data and an identified media object for display on an output device, and to receive an input to store a document in storage without the identified media object;

FIG. 3 is a block diagram of an example display to display the rendering data and identified media object in a foreground and/or background of the display;

FIG. 4 is a block diagram of an computing device to receive, process, and output rendering data and to display the identified media objects contextually relevant to the rendering data;

FIG. 5 is a flowchart of an example method performed on a computing device to receive rendering data to process, retrieve identified media contextually relevant to the rendering data, and output the identified media;

FIG. 6A is a block diagram on an example display with an email and media objects on a foreground and background of the display; and

FIG. 6B is a block diagram for an example display with an email and media objects within void space on a foreground of the display.

### DETAILED DESCRIPTION

In viewing documents on a computing device, media objects, such as pictures, video, and audio provide emotional and useful context to the documents. This provides a more valuable experience to the user viewing the document. However, these media objects generally need to be added by the creator of the document or by the application. This can be time consuming for the creator and/or user as the relevant media objects need to be identified to manually to insert into each document. Alternatively, each application on a computing device needs to be configured to insert media objects into the document. However, these media objects may not provide a valuable experience to the user as the media objects may be unrelated to the document. For example, the application may retrieve the media object from a database on a network, rather than from a local storage.

To address these issues, example embodiments disclosed herein utilize an operating system to identify and output contextually-relevant media (e.g., images, video, or audio) that is relevant to the data currently outputted by an application running within the operating system. In particular, example embodiments provide a processor to execute an application associated with an operating system, wherein the application transmits rendering data to the operating system. The rendering data identifies visual objects for display by the operating system. The operating system may then process the rendering data received from the application to identify a media object contextually relevant to the rendering data.

Providing media objects in conjunction with rendering data provides more valuable information to users viewing the documents. For example, the user may have received an email from a friend on vacation and, as such, pictures displaying the friend and/or the location of the friend's vacation may be displayed. This creates a more personal experience as the pictures may be personal to the user of the computing device.

Additionally, because the operating system manages the identification and display of contextually-relevant information, this minimizes the need for each application developer to separately implement the functionality. Furthermore, because the operating system identifies the media using rendering data provided by the application in the normal course of execution, the application developer can take advantage of this feature while making few, if any, changes to the application code.

The OS-centric approach also provides benefits from the perspective of the user. In particular, the user of the computing device can centrally control whether a computing device displays the identified media objects with the document, rather than the user configuring each application associated with the computing device. For example, the user may configure a setting within the operating system to identify and display media objects relevant to the rendering data, rather than having to configure each application to identify and display these media objects. Further still, the identified media objects may be contextually relevant to the rendering data and this may be user-specific, as opposed to application-specific. In keeping with the email example, the media objects may include pictures of the friend the user may have stored locally, rather than advertisements the application retrieves from a network.

Additionally, in the various examples disclosed herein, the rendering data includes display commands and display data for display on an output device. For example, the rendering data may correspond to a command provided from the application to the OS using a predetermined API. In these examples, the operating system retrieves the identified media objects from a local storage and displays the media objects in conjunction with the document. Based on receiving an input to close the document, the processor stores the document without the identified media object. This allows the document to be displayed with identified media objects in a dynamic manner on each computing device and creates a more user-customized experience, while avoiding the need to store the contextually-relevant media with each document. For example, one computing device may display different media objects with a document than another computing device since the identified media objects may vary across local storage devices. Yet, further still, storing a document without the identified media enables the document to be displayed in an ever-changing manner to the user. For example, if any changes occur to the document, these changes will be utilized within the document for identifying media objects contextually relevant to the changes once the document is to be displayed on the computing device.

In another embodiment, once the rendering data is displayed on an output device, void space is detected adjacent to the rendering data to display the identified media object in the void space. Detecting the void space to display the identified media object, enables the display to respond in a flexible manner to the rendering data. For example, the rendering data may be displayed on a foreground of a display, thus the void space within the foreground and/or background may be used for display of the identified media object.

In summary, example embodiments disclosed herein provide a more valuable and aesthetically satisfying experience to a user of a computing device when viewing a document. Further, the computing device responds in a dynamic manner to control what media objects to display to the user allowing more personal context. In addition, because the operating system manages the display of relevant content in an application agnostic manner, this minimizes the need for application-specific customization by application developers.

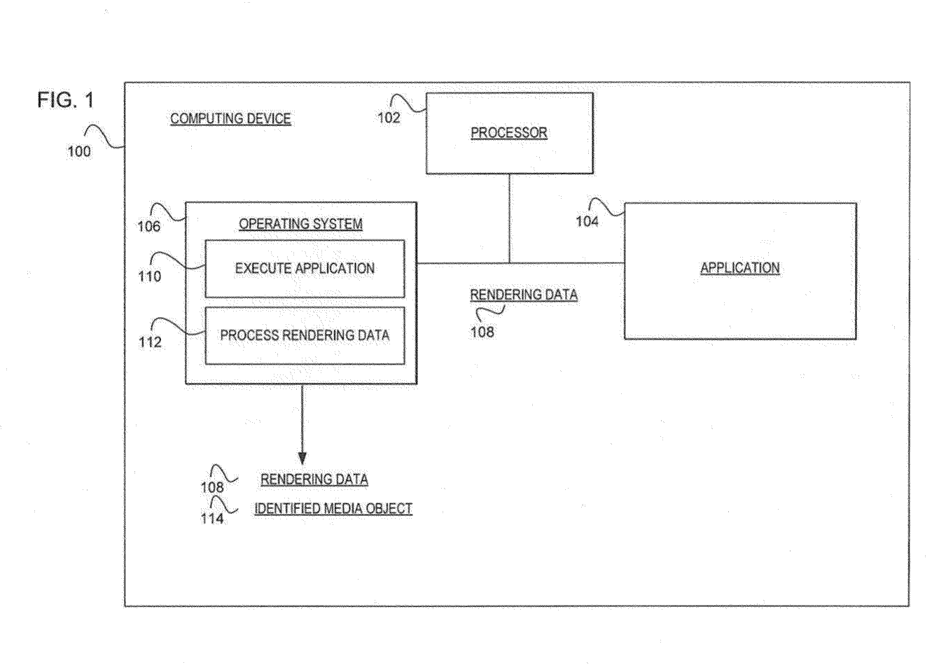

Referring now to the drawings, FIG. 1 is a block diagram of an example computing device 100 including processor 102 and application 104 to transmit rendering data 108 from the application 104 to an operating system 106. The operating system 106 includes modules 110 and 112 to execute the application and process the rendering data, respectively. Further the operating system 106 outputs the rendering data 108 and identified media object 114. Embodiments of the computing device 100 include a client device, personal computer, desktop computer, laptop, a mobile device, or other computing device suitable to include components 102, 104, and 106.

The processor 102 executes the application 104 and the operating system 106 to transmit the rendering data 108 to the operating system 106. Embodiments of the processor 102 include a microchip, chipset, electronic circuit, microprocessor, semiconductor, microcontroller, central processing unit (CPU), graphics processing unit (GPU), visual processing unit (VPU), or other programmable device capable of executing the application 104 and the operating system 106.

The application 104 generates the rendering data 108 for transmission to the operating system 106. The application 104 is considered associated with the operating system 106 as the application 104 may be specific to the computing device 100. For example, the user of the computing device 100 may be authorized to execute different applications 104 than another computing device 100. As such, the operating system 106 may be authorized to execute particular applications 104. Embodiments of the application 104 include any set of instructions executable by processor 102 that enable the computing device 100 to perform a task. Although FIG. 1 depicts application 104 located on the computing device 100, it should not be limited to this embodiment, as the application 104 may reside on a server within a network.

The rendering data 108 is transmitted from the application 104 to the operating system 106. In one embodiment, the rendering data 108 includes a display command and display data. The display command may be provided, according to an application programming interface (API). The API is an interface by which software components communicate with one another. For example, the API may include a command or other instruction that enables the application 104 to instruct the operating system 106 to display the rendering data 108 on an output device. In a further embodiment, the rendering data 108 corresponds to a document related to the application 104. For example, the rendering data may include the text in the document to display on the output device of the computing device 100. In another embodiment, the rendering data 108 obtained by the operating system 106 may include the display command and display data, while the rendering data 108 output from the operating system 106 may include the display data. In this embodiment, keeping with the previous example, the rendering data 108 from the application 104 to the operating system 106 may include the text in the document and instructions on how to display the text on the output device, while the rendering data 108 outputted from the operating system 106 includes the text to display.

The operating system 106 receives the rendering data 108 from the application 104. The operating system 106 includes a program to manage computer components associated with a computing device 100 and provides services for the application 104. For example, the operating system 106 may include the services for launching the application 104. Embodiments of the operating system 106 include any set of executable instructions executable by processor 102 that enable the computing device 100 to provide services for the application 104.

The module 110 executes the application associated with the operating system 108. Embodiments of module 110 include any set of instructions executable by processor 102o execute the application associated with the operating system 106. In a further embodiment, the module 110 launches the application 104 associated with the operating system 106.

The module 112 processes the rendering data obtained by the operating system 106 from the application 104 to identify the media object contextually relevant to the rendering data 108. Contextual relevance is the relation of text and/or images within the rendering data 108 to the identified media object 114. Embodiments of module 112 include any set of instructions executable by processor 102 to process the rendering data 108 transmitted by the application 104 to the operating system 106. Further embodiments of module 112 include the operating system 106 examining, scanning, and/or recognizing text or an image within the rendering data 108 to identify the contextually relevant media object 114. In another embodiment of module 112, the operating system obtains the identified media object 114 from a local storage area on the computing device 100 or from a network. For example, in a word processing document discussing Hawaii as a vacation, the operating system 106 may process the rendering data at module 112 and recognize the text of Hawaii and as such, the operating system 106 may retrieve images and/or audio of Hawaii from a local store on the computing device 100 or from the network to output these identified pictures and/or audio of Hawaii.

The identified media object 114 is then transmitted from the operating system 106 to an available output device. In one embodiment, the identified media object 114 is transmitted to an output device coupled to the computing device 100 for display. The identified media object 114 may include an image, video, and/or audio for output. In a further embodiment, the identified media object 114 may be displayed on the display device, while in a further embodiment, the identified media object 114 may include playing audio using a speaker of the output device.

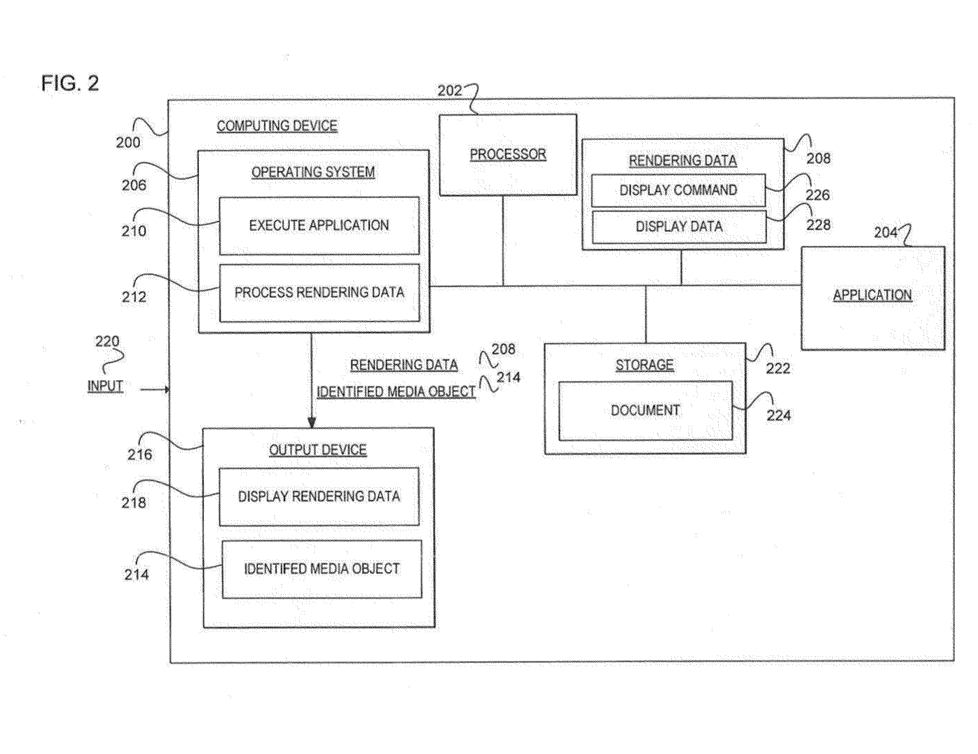

FIG. 2 is a block diagram of an example computing device 200 including processor 202 and application 204 to transfer rendering data 208 comprising display command 226 and display data 228, and operating system 206 to receive the rendering data 208. Additionally, the operating system 206 processes the rendering data at module 212 to output an identified media object 214 to an output device 216 for display and/or output audio. Further, the computing device 200 may receive an input 220 to store a document 224 in storage 222 without the identified media object 214. The computing device 200 may be similar in functionality and structure to computing device 100 of FIG. 1.

Processor 202 accesses the application 204 and the operating system 206 to execute the application at module 210, such that application 204 transmits the rendering data 208 to the operating system 206. Additionally, the processor 202 processes the rendering data 208 using the operating system 206 at module 212 to identify the media object 214 that is contextually related to the rendering data 208. Further the processor 202 executes the operating system 206, such that the operating system 206 outputs the rendering data 208 and the media object identified at module 212. The processor 202 may be similar in functionality and structure of the processor 102 as above in connection with FIG. 1.

The application 204 transfers the rendering data 208 to the operating system 206 when processor 202 executes the application associated with the operating system 206 at module 210. The application 204 may be similar in functionality of the application 104 as above in connection with FIG. 1.

Rendering data 208 identifies visual objects for display by the operating system 206 at the output device 216. In one embodiment, the rendering data 208 includes the display command 226 and the display data 228. The display data 228 includes the visual objects for display on the output device 216 and may include text, images, or video. By displaying the visual objects, the rendering data conveys information to a user of the computing device 200. The display command 226 includes instructions on how to display the display data 228. For example, the rendering data 208 may include an email, thus the display data 228 includes the text of the email (i.e., the visual objects) to be displayed to a user of the computing device 200. In this example, the display command 226 includes instructions on how to display the text of the email on the output device 216 to the user. In another embodiment rendering data 208 is further displayed on the output device 216 at module 218. Yet, in a further embodiment rendering data 208 corresponds to document 224. In keeping with the previous example, the email is considered the document. The rendering data 208 may be similar in functionality and structure of the rendering data 108 as above in connection with FIG. 1.

Display command 226 operates as an interface between the application 204 and operating system 206 to instruct operating system 206 how to display data on the output device 216. The display command 226 includes instructions on how to display the rendering data 208 on the output device 216. For example, display command 226 may identify a type of object to be displayed (e.g., text, an image, etc.) and a position of the object to be displayed (e.g., X-Y coordinates). Thus, in some embodiments, the display command 226 is formatted according to an Application Programming Interface (API). The API is source code intended to be used as an interface between software components to communicate (in this case, the application 204 and the operating system 206).

Display data 228 includes the visual objects within the rendering data 208 for display by the operating system 206 on the output device 216. Embodiments of the display data 228 include text, image, and/or video.

Operating system 206 receives the rendering data 208 from the application 204 and processes the rendering data 208 to identify the media object 214 that is contextually relevant to the rendering data 208. Contextual relevance is the measure of how related text or images within rendering data 208 are to the media object 214. Embodiments of the identified media object 214 include an image, video, and/or audio. For example, the rendering data 208 may include text within a word processing document discussing countries to vacation and the operating system 206 processes this text to identify media object 214. In this example, the identified media object 214 may include maps and/or images of those countries and/or audio of various songs from those countries. Additionally, the operating system 206 transmits the rendering data 208 and the identified media object 214 to the output device 216. The operating system 206 may be similar in functionality and structure of the operating system 106 as above in connection with FIG. 1.

The processor may execute the application associated with the operating system 206 at module 210. The module 210 may be similar in functionality and structure of the module 110 as above in connection with FIG. 1.

After receiving the rendering data 208, the operating system 206 processes the rendering data at module 212 to identify the media object 214 contextually relevant to the rendering data 208. The module 212 may be similar in functionality and structure of the module 112 as above in connection with FIG. 1.

The identified media object 214 is sent from the operating system 206 to the output device 216. The identified media object 214 is contextually related to the rendering data 208. In one embodiment, the identified media object 214 may be sent after the rendering data 208. In this embodiment, the rendering data 208 may be displayed on the output device 216 while the operating system 206 processes the rendering data at module 212 to identify the media object 214. The media object may then be displayed and/or played at the output device 216 after the rendering data is displayed at module 218. In an alternative embodiment, the identified media object 214 is sent with the rendering data 208 so that when the rendering is displayed at module 218, the identified media object 214 may be displayed and/or played in conjunction with display of the rendering data at module 218. The identified media object 214 may be similar in functionality and structure of the identified media object 114 as above in connection with FIG. 1.

The operating system 206 outputs the rendering data 208 and the identified media object 214 to the output device 216. Embodiments of the output device 216 include a display and/or a speaker to display and/or play the identified media object 214 from the operating system 206. A further embodiment of the output device 216 includes displaying the rendering data 208. In this embodiment, the rendering data 208 includes the visual objects for display on the output device 216. Further embodiments of displaying the identified media object 214 with the rendering data 208 are seen in later figures.

The output device 216 includes module 218 to display the rendering data. The module 218 interacts with display command 226 to display the display data 228 by the operating system 206 on the output device 216. Embodiments of the display rendering data module 218 include a media buffer, storage, memory, and/or hardware capable of displaying the rendering data and operating in conjunction with the output device 216.

The input 220 is a signal that may be received by the processor 202 of the computing device 200 to close the document 224. Based on receiving this input 220, the processor 202 stores the document 224 in storage 222 without the identified media object 214. An embodiment of the input 220 may include a user-initiated request to close the document 224 with the rendering data that is displayed and/or playing on the output device 216. In other embodiments, input 220 may originate from a computing device 200 that initiates a request to close the document 224. For example, a user of the computing device 200 may desire to exit the application 204 and as such may request to close the document 224, by using an interface to request to close the document 224.

The rendering data 208 is displayed on the output device at module 218 which corresponds to document 224. The application 204 enables the computing device 200 to perform a specific task and the document 224 is a file with content related to the application 204 and intended to convey information (i.e., display the visual objects) to the user of the computing device 200. Embodiments of the document 224 include a word processing file document, email, spreadsheet file document, a media file document, a Portable Document Format (PDF) file document, a text file document, or other files or documents.

Storage 222 stores and/or maintains the document 224 without the identified media object 214. Embodiments of the storage 222 may include a local storage, memory, memory buffer, cache, non-volatile memory, volatile memory, random access memory (RAM), an Electrically Erasable Programmable Read-Only memory (EEPROM), storage drive, a Compact Disc Read-Only Memory (CDROM), or other physical storage device capable of storing the document 224. Storing the document 224 without the identified media 214 enables the document 224 to be displayed in an ever-changing manner to the user of the computing device 200. For example, if any changes occur to the document 224, this newest version will be utilized for identified media objects 214 contextually relevant to the changes.

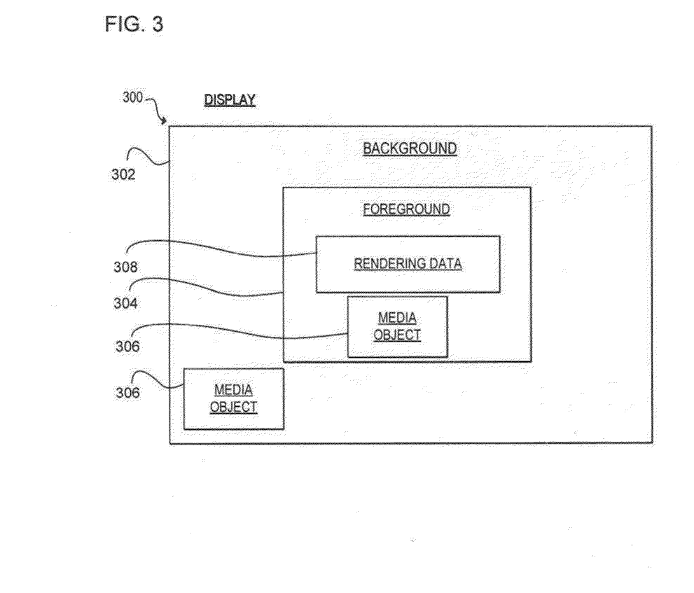

FIG. 3 is a block diagram of an example display 300 to display rendering data 308 and identified media object 306 in a foreground 304 and/or background 302 of the display 300. Although FIG. 3 depicts the display 300 as divided into two different display components (the foreground 304 and the background 302), it may also include a single display component. For example, there may be a single foreground 308 and as such, this embodiment would include a single display component. The display 300 is an output device for displaying rendering data 308 and/or a media object 306 to a user of a computing device. Embodiments of the display 300 include a visual display, tactile display, electronic display, digital display, or other display 300 capable of displaying rendering data 308 and/or the media object 306.

The rendering data 308 includes visual objects for display by the operating system on the display 300. The visual objects may include text and/or images within the rendering data 308 to display. An embodiment of the rendering data 308 includes displaying on the foreground 304, another embodiment includes displaying the rendering data 308 on the background 302, and a further embodiment includes displaying the rendering data 308 on a combination of the foreground 304 and the background 302. The rendering data 308 may be similar in functionality and structure of the rendering data 108 and 208 as above in connection with FIG. 1 and FIG. 2.

The foreground 304 is considered the focal-centered or forefront component of the display 300. The foreground 304 displays the rendering data 308 and/or the media object 306.

The media object 306 which is contextually relevant to the rendering data 308 is displayed on display 300. The media object 306 is considered the media object as identified by an operating system by processing the rendering data 308. An embodiment of the media object 306 includes displaying the media object 306 on the foreground 304, another embodiment includes displaying the media object 306 on the background 302, and a further embodiment includes displaying the media object 306 on a combination of the foreground 304 and the background 302. The media object 306 may be similar in functionality and structure of the identified media object 114 and 214 as above in connection with FIG. 1 and FIG. 2.

The background 302 is considered the back portion, or less focal-dominant component to the display 300. In one embodiment, the rendering data 308 is displayed in the foreground 304 of the display 300 while the media object 306 is displayed in the background 302 of the display 300.

Further embodiments of the example display 300 to display the media object 306 are seen in later figures.

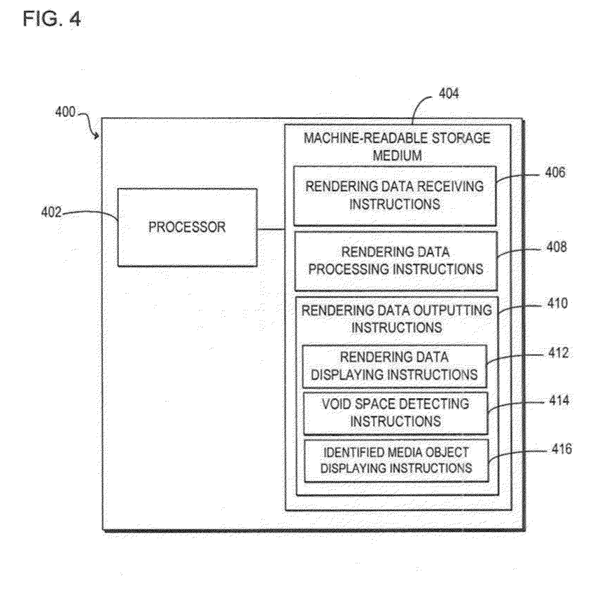

FIG. 4 is a block diagram of an example computing device 400 for receiving and outputting rendering data. Although the computing device 400 includes processor 402 and machine-readable storage medium 404, it may also include other components that would be suitable to one skilled in the art. For example, the computing device 400 may include storage 222 or output device 216 as in FIG. 2. Additionally, the computing device 400 may be similar in structure and functionality of the computing devices 100 and 200 as set forth in FIG. 1 and FIG. 2, respectively.

The processor 402 may fetch, decode, and execute instructions 406, 408, 410, 412, 414, and 416. Processor 402 may be similar in functionality and structure of the processor 102 and 202 as above in connection with FIG. 1 and FIG. 2, respectively. Specifically, the processor 402 executes: receiving rendering data instructions 406, processing rendering data to identify a media object contextually relevant to the rendering data instructions 408, outputting the rendering data and the identified media object to an output device instructions 410, display the rendering data on the output device instructions 412, detecting void space adjacent to the rendering data instructions 414, and displaying the identified media objects within the void space instructions 416.

The machine-readable storage medium 404 may include instructions 406, 408, 410, 412, 414, and 416 for the processor 402 to fetch, decode, and execute. The machine-readable storage medium 404 may be an electronic, magnetic, optical, memory, storage, flash-drive, or other physical device that contains or stores executable instructions. Thus, the machine-readable storage medium 404 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 404 may include an application and/or firmware which can be utilized independently and/or in conjunction with the processor 402 to fetch, decode, and/or execute instructions of the machine-readable storage medium 404. The application and/or firmware may be stored on the machine-readable storage medium 404 and/or stored on another location of the computing device 400.

Instructions 406 include the operating system receiving rendering data from an application. The rendering data is data which may identify visual objects for display by the operating system. Embodiments of the rendering data include a display command and/or display data. An embodiment of instructions 406 include the processor executing the application associated with the operating system. The application may be specific to the computing device 400 and as such, the operating system and processor 402 may be authorized to execute particular applications. In this embodiment, the computing device 400 may execute different applications than the applications another computing device may execute.

Instructions 408 include the operating system processing the rendering data received by instructions 406 to identify a media object contextually relevant to the rendering data. Contextual relevance includes how related text or images within rendering data is to the media object. For example, the text “Hawaii” may include media objects which may be images of palm trees, a map of Hawaii, or Hawaiian song. Embodiments of instructions 408 include analyzing, examining, scanning, and/or recognizing text and/or image within the rendering data to identify how it may relate to the media object.

Instructions 410 include the operating system outputting the rendering data and the media object identified by instructions 406 to the output device on the computing device 400. Embodiments of instructions 410 include the rendering data being transmitted prior to the transmission of the identified media object. Additionally, an embodiment of instructions 410, include any one or combination of instructions 412, 414, and 416.

Instructions 412 include the operating system displaying the rendering data on the output device. Embodiments of the rendering data include the display command and display data. The display command includes instructions on how to display the rendering data. For example, the rendering data may include an email, thus the display data includes the text of the email and the display command includes instructions on how to display the text of the email on the output device.

Instructions 414 include detecting a void space adjacent to the rendering data on the output device. The void space is a location on the display of the output device where there is an absence of rendering data that is being displayed. An embodiment of instructions 414 include mapping the display into coordinates and analyzing these coordinates to determine the void space. In another embodiment, instructions 414 detect the void space by scanning the display. In keeping with the previous example, the rendering data includes the text in an email, the text being displayed on the output device. In this example, the void space would be the area on the display absent text from the email.

Instructions 416 include displaying the media object identified by instructions 408, within the void space. An embodiment of instructions 416 include using the detected void space to display the media object. In the previous example, the identified media object may include an image contextually relevant to the email and as such would display in the void space. Further embodiments of displaying the media object in the detected void space may be seen in later figures.

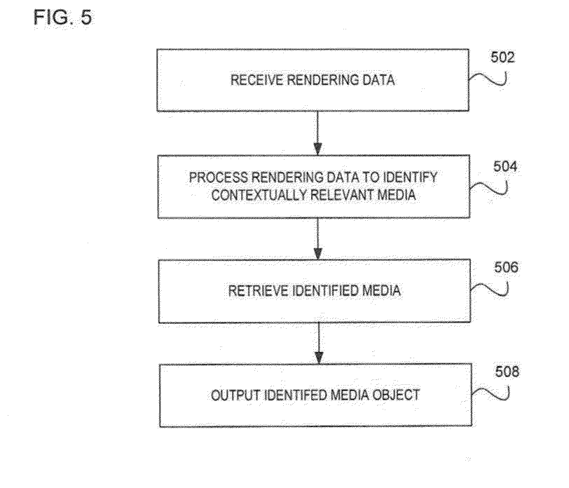

FIG. 5 is a flowchart of an example method performed on a computing device to receive rendering data 502 and output an identified media object 508. Although FIG. 5 is described as being performed on computing device 100 as in FIG. 1, it may also be executed on other suitable components as will be apparent to those skilled in the art. For example, FIG. 5 may be implemented in the form of executable instructions on a machine readable storage medium, such as storage 222 in FIG. 2.

At operation 502 the operating system receives rendering data from the application. At this operation 502, the processor executes the application associated with the operating system to transmit the rendering data from the application to the operating system. The rendering data identifies visual objects for display by the operating system. The visual objects may include text and/or images for display on an output device of the computing device. In an embodiment of operation 502, the rendering data including a display command and display data are transmitted to the operating system. Operation 502 may be similar in functionality to instructions 406, as described above in connection with FIG. 4.

At operation 504 the operating system processes the rendering data to identify the contextually relevant media object. Embodiments of operation 504 include metadata associated with text or images within the rendering data and as such, the operating system may recognize the metadata to identify a contextually relevant media object. Further embodiments of operation 504 include scanning, examining, recognizing text and/or images within the rendering data to display on the output device. Yet, another embodiment of operation 504 includes instructions for processing the text and/or the image within the rendering data to identify the media object contextually relevant to the rendering data. For example, the rendering data may include text within an email for suggestions to restaurants. As such, the operating system processes the rendering data and recognizes the text as restaurants and identifies images and/or audio relevant to the restaurants, such as pictures of the restaurants. Operation 504 may be similar in functionality of the module 112 and 212 as above in connection with FIG. 1 and FIG. 2 and also instructions 408, as described above in connection with FIG. 4.

At operation 506 the operating system retrieves the identified media object at operation 504. Embodiments of operation 506 include retrieving the identified media object from a local storage on a computing device. In this embodiment, the identified media object at 504 may include a user's personal information for customization. For example, this may include their personal pictures stored on the storage at the computing device. In a further embodiment of operation 506, the operating system may communicate with the processor to retrieve the identified media object from storage on a network. In keeping with the previous example, the pictures of the restaurant may be retrieved from the local storage on the computing device and/or from the network which may include a database with the restaurant images. In an additional embodiment, operation 506 may be performed simultaneously with operation 504. For example, while the operating system is processing the rendering data at operation 504, once a media object is identified, the operating system may retrieve the identified media object at operation 506 while continuing to process the rendering data at operation 504.

At operation 508, the operating system outputs the identified media object. In an embodiment of operation 508, the operating system also outputs the rendering data. In a further embodiment of operation 508, an output device may display the rendering data and play and/or display the identified media object. In an additional embodiment of operation 508, the rendering data is displayed, the rendering data corresponding to a document. In this embodiment, an input may be received by the processor to close the document at which the document is stored without the identified media. Operation 508 may be similar in functionality to instructions 410, as described above in connection with FIG. 4.

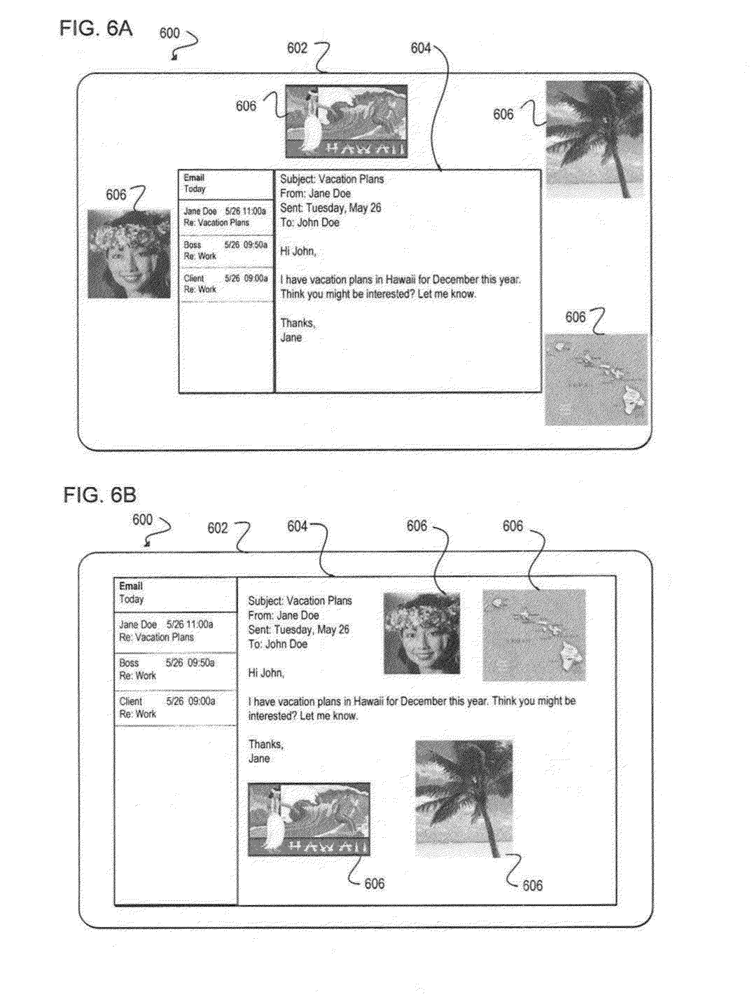

FIG. 6A and FIG. 6B are block diagrams of an example display 600 with an email and media objects 606 which are contextually relevant to the email. FIG. 6A depicts an email on the foreground 604 and media objects 606 on the background 602 of the display while FIG. 6B depicts the media objects 606 displayed within the void space of the email. Display 600 is an output device associated with a computing device to display the media objects 606 and the rendering data which includes the text of the email. The display 600 may be similar in functionality and structure to display 300 as described above in connection with FIG. 3. Further although FIG. 6A and FIG. 6B depict the media objects 606 as images, embodiments should not be limited to this embodiment as the media objects 606 may be an audio track.

The foreground 604 of the display 600 depicts rendering data which may include the text in the email. The email from Jane Doe to John Doe discusses vacation plans to Hawaii. Thus, an operating system of the computing device processes this text within the email to identify Hawaii and/or Jane Doe. The foreground 604 may be similar in functionality and structure to foreground 304 as described above in connection with FIG. 3.

The background 602 of the display 600 displays the media objects 606 in FIG. 6A. The background may be similar in functionality and structure to the background 302 as described above in connection with FIG. 3.

The media objects 606 are contextually relevant to the email on the foreground 604. For example, in the email from Jane Doe to John Doe it discusses going to Hawaii for a vacation, as such the contextually relevant media objects 606 include a palm tree, map of Hawaii, Hawaiian picture with a surfer, and a woman's picture. The media objects 606 are considered to be related to Hawaii and/or Jane Doe. As such, the woman's picture may be a picture of the recipient of the email, Jane Doe. The picture of Jane Doe depicts the customization of the media objects 606 to the John Doe as this picture may be a personal picture in local storage. Further, embodiments of FIG. 6A and FIG. 6B should not be limited to the specific media objects 606 depicted as the media objects 606 may include an image of John Doe in Hawaii and/or a Hawaiian audio track. Additionally, FIG. 6A and FIG. 6B should not be limited depicting several media objects 606 as these figures may include a singular media object.

In FIG. 6B, the foreground 604 displays the media objects 606 which are contextually relevant to the email in the void spaces of the email. An operating system of a computing device processes the text within the rendering data that comprises the email on the foreground 604. In this manner, the operating system may detect the void spaces of the email to place media objects 606 which are identified as contextually relevant to the email. Thus, the display 600 depicts the images of Hawaii, palm tree, surfer, and woman's picture since these are relevant to Hawaii and/or Jane Doe.

The embodiments described in detail herein provide a more valuable and aesthetically satisfying experience to a user of computing device viewing a document in conjunction with media objects. Further, the computing device responds in a dynamic manner to control what media objects. to display to the user allowing more personal context. Still further, because the operating system identifies the contextually relevant content, the user may view the relevant content when executing any application without the need for each application to be individually customized to include this functionality.

We claim:

1. A computing device comprising:
a processor to:
execute an application associated with an operating system to transmit rendering data from the application to the operating system, the rendering data identifying visual objects for display by the operating system;
process, by the operating system, the rendering data transmitted from the application to the operating system to identify a media object contextually relevant to the rendering data; and
output, by the operating system, the rendering data and the identified media.

2. The computing device of claim 1 wherein the rendering data includes a display command and display data provided from the application to the operating system.

3. The computing device of claim 2 wherein the display command is provided according to an application programming interface (API).

4. The computing device of claim 1 wherein the processor is further to:
display the rendering data, the rendering data corresponding to a document; and
based upon receiving an input to close the document, store the document without the identified media.

5. The computing device of claim 1 wherein to output the rendering data, the operating system displays the rendering data on a display device.

6. The computing device of claim 1 wherein to output the identified media includes at least one of a display and a speaker.

7. A non-transitory machine-readable storage medium encoded with instructions executable by a processor of a computing device, the storage medium comprising instructions to:
receive, by an operating system, rendering data provided from an application executing within the operating system, wherein the rendering data is for display by the operating system;
process, by the operating system, the rendering data received from the application to identify a media object contextually relevant to the rendering data; and
output the rendering data and the identified media object to an output device of the computing device.

8. The non-transitory machine-readable storage medium including the instructions of claim 7, wherein to output the identified media object to the output device of the computing device includes at least one of displaying the identified media object on a display device and outputting the identified media object to an audio device.

9. The non-transitory machine-readable storage medium of claim 7, further comprising instructions to:
display the rendering data on the output device;
detect a void space adjacent to the rendering data, the void space including the absence of the rendering data; and
display the identified media object within the void space.

10. The non-transitory machine-readable storage medium including the instructions of claim 7 wherein the instructions to output the rendering data further comprise at least one of:
instructions to display the rendering data on a foreground of a display on the output device while the identified media object is displayed on a background of the output device; and
instructions to display the rendering data on the display of the output device while the identified media object is displayed on the foreground of the display.

11. The non-transitory machine-readable storage medium of claim 7, further comprising instructions to:
display the rendering data on the output device, the rendering data corresponding to a document; and
based upon receiving an input to close the document, store the document without the identified media object.

12. The non-transitory machine-readable storage medium of claim 7, wherein the instructions to process the rendering data to identify the media object contextually relevant to the rendering data comprise instructions for processing a text or an image within the rendering data.

13. The non-transitory machine-readable storage medium of claim 7, wherein the rendering data is provided according to an application programming interface (API).

14. A method executed on a computing device, the method comprising:
receiving, by the operating system, rendering data provided by an application for display by the operating system, wherein the rendering data is received as part of a display command from the application;
processing the rendering data to identify a media object contextually relevant to the rendering data;
retrieving the identified media object from a memory; and
outputting the identified media object to an output device of the computing device.

15. The method of claim 14 further comprising:
displaying the rendering data on the output device, the rendering data corresponding to a document; and
based upon receiving an input to close the document, store the document without the identified media object.
